(19) United States
(12) Patent Application Publication
(10) Pub. No.: US 2013/0068600 A1
(43) Pub. Date: Mar. 21, 2013

(54) Switching Device

(71) Applicants: Michael GEPPERT, Bingen (DE); Gerd RUDOLPH, Aspisheim (DE)

(72) Inventors: Michael GEPPERT, Bingen (DE); Gerd RUDOLPH, Aspisheim (DE)

(73) Assignee: METHODE ELECTRONICS MALTA LTD., Mriehel (MT)

(21) Appl. No.: 13/425,596

(22) Filed: Mar. 21, 2012

(30) Foreign Application Priority Data
Mar. 22, 2011 (DE) 102011014765.9
Apr. 13, 2011 (DE) 102011016945.8

(51) Int. Cl. H01H 5/06

(52) U.S. Cl. 200/464

(57) ABSTRACT

A switching device has a housing, an actuator, and at least two metal contact elements. At least one contact element is a common contact point and at least one contact element is a switching contact. The contact elements are electrically contactable from the outside of the housing. The switching device has a snap-action switching mechanism actuated when the actuator is pressed. The snap-action switching mechanism has first and second actuator-elements with a tension spring therebetween. The first actuator-element has first and second ends with one switching contact mounted adjacent the first end and a pivot mount at the second end. The second end also forms the common contact point. The second actuator-element has first and second ends with the first end adapted to be actuated via the actuator and the second end being pivot-mounted on the inner edge of the housing opposite to the common contact.

### CROSS-REFERENCE TO RELATED APPLICATIONS

This application claims priority to German Patent App. No. 10 2011 014 765.9, filed on Mar. 22, 2011, and German Patent App. No. 10 2011 016 945.8, filed on Apr. 13, 2011, the disclosures of which are incorporated by reference herein.

### BACKGROUND AND SUMMARY

A switching device is specified which is capable of accurately switching between at least two switch positions.

A switching device as mentioned above is disclosed in JP 2010073662 A. Said switching device has the disadvantage that it is formed by a very complex assembly.

In consideration of this situation, the primary object of the invention is to provide a switching device according to the preamble of claim 1 which has a simpler assembly and operates more reliably.

The solution of this technical problem is provided with the features of the main claim, whereas advantageous designs and further developments of the invention can be inferred from the dependent claims.

The technical problem is solved in the switching device which has a housing, an actuator for receiving a pressure two or more actuation and at least two or more metal contact elements. At least one contact element forms a common contact point, and at least one contact element is a switching contact. The contact elements are electrically contactable from the outside of the housing. The switching device has a snap-action switching mechanism which is actuated when the actuator is pressed into the designated position. The snap-action switching mechanism has at least a first actuator-element on which at least one contact part for the disconnection and/or contacting with the at least one switching contact is mounted in the region of a first end. The first actuator-element is pivot-mounted with the second end at the common contact point. The snap-action switching mechanism has a second actuator-element which is capable of receiving a pressure actuation by means of the actuator via a first end. The second actuator-element is pivot-mounted at its second end on the inner edge of the housing opposite to the common contact of the housing. The second actuator-element is pivot-mounted at its second end on the inner edge of the housing which is opposite to the transverse side with the common contact of the housing. A tension spring is located between the first actuator-element and the second actuator-element.

A preferred embodiment of the switching device is characterized in that the second actuator-element has at least one recess at its second end. Preferably, at least one projection engages with the recesses, with the projection being attached to an inner edge of the housing on which the second end of the second actuator-element is mounted. Due to the projection, the second actuator is secured against lateral slipping. Preferably, the shape of the projection is adapted to the shape of the recess of the second actuator such that they can engage with each other. Instead of a recess, two or more recesses can also be provided at the second end of the second actuator-element. Accordingly, in this case there is a plurality of suitable projections on the inner edge of the housing.

Another preferred embodiment of the switching device is characterized in that the contact part being connected to the first actuator-element is pre-stretched against the switching contact. Due to the pre-stretching of the contact part, it is ensured that the contact part produces sufficiently high sliding resistance, which has to be overcome by the movement of the snap-action switching mechanism. In the event that the tensioning force of the tension spring between the first and second actuator-element is higher than the sliding resistance of the contact part, the snap-action switching mechanism snaps over and the contact part snaps from the switching contact into a resting position and/or from the resting position to the switching contact. In the event that no more pressure is applied to the actuator, the snap-action switching mechanism snaps back into its stable starting position due to the tensioning force of the tension spring. At this, the contact part slips back to the switching contact and/or into the resting position.

Preferably, at least one switching contact is arranged laterally towards the inner wall of the housing. The contact part connected to the first actuator-element is arranged between the first actuator-element and the switching contact. Preferably, the switching contact is arranged such that it is in contact with the inner surface of the housing, or it is disposed in a recess of the inner surface. In an embodiment of the switching device having two switching contacts, the inner wall between the switching contacts preferably forms a smooth transition. Thus, the contact part can slide between the two switching contacts without having to overcome an additional obstacle. For a defined desired increase and/or reduction of the sliding resistance of the contact part, the switching contact itself and/or switching contacts themselves may, however, have recesses or elevations.

Another preferred embodiment of the switching device is characterized in that at least two second metal contact elements are arranged parallel to at least two first metal contact elements. In this case, a contact element forms a common contact, and the further contact element is a switching contact. The common contacts and the switching contacts of the first two metal contact elements are arranged parallel to the second two metal contact elements in each case. Preferably, a snap-action switching mechanism is each arranged between a pair of two metal contact elements, respectively.

Another preferred embodiment of the switching device is characterized in that said switching device has further arrangements of metal contact elements. Preferably, a snap-action switching mechanism is arranged between two adjacent pairs of at least two metal contact elements.

In this case, metal contact elements can also be switched on both sides by means of two synchronizing snap-action switching mechanisms. In an embodiment of the switching device having a plurality of snap-action switching mechanisms, the latter are preferably synchronized by means of a common actuator.

Another preferred embodiment of the switching device is characterized in that the second or further metal contact elements are electrically insulated from the at least two first metal contact elements and from each other, respectively.

Due to the assembly of the switching device, it is possible to provide an absolutely synchronized switch, wherein an individual switch unit preferably comprises three contact elements comprising a common contact and two switching contacts. It is possible to combine a plurality of switch units into one unit in order to achieve higher reliability.

The second and/or further metal contact elements are electrically contactable from the outside of the housing. For this purpose, the metal contact elements preferably project sufficiently from the bottom of the housing.

Another preferred embodiment of the switching device is characterized in that it has a further metal contact element which can be preferably electrically contacted from the outside of the housing. For each group of two contact elements, i.e. common contact point and switching contact, a further contact element is provided. The further contact element forms a further switching contact. Preferably, the snap-action switching mechanism is provided for the disconnection and/or contacting between the first switching contact and the second switching contact.

The contact elements, at least the first actuator-element as well as the contact part and the tension spring consist of an electrically conductive material, preferably electrically conductable metal, wherein the individual components can be made of different electrically conductive materials. The second actuator-element is not necessarily part of an electrical connection and can thus consist of electrically insulating materials, such as plastics, as well electrically conductive materials such as metals.

A preferred embodiment of the switching device is characterized in that the first actuator-element has a further contact part for the disconnection and/or contacting with the two further switching contacts, wherein the further contact part is pre-stretched against the two further switching contacts.

Preferably, the two contact parts connected to the first actuator-element are electrically insulated from each other.

A preferred embodiment of the switching device is characterized in that the first actuator-element has two components which are mechanically connected to each other. In a preferred embodiment of the switching device, the two components are mechanically connected to each other by means of an insulating element. Due to the mechanical connection of the two components of the first actuator-element, the two components function as a common element, wherein the individual components are electrically insulated from each other.

A preferred embodiment of the switching device is characterized in that the contact part is divided into one or a plurality of spring elements. Preferably, at least two of the spring elements of the contact part are of different lengths. If the contact part is designed with spring elements of different lengths, a redundant design of the contact part is achieved. Due to this design of the contact part, it is ensured at any time that the contact part has a certain electrical contact with the switching contacts when it is in the region of the latter.

A preferred embodiment of the switching device is characterized in that at their ends abutting on the switching contacts, the spring elements each have at least one switching contact point projecting from the spring elements. The switching contact points of the spring elements form the electrical connection to the switching contacts.

Another preferred embodiment of the switching device is characterized in that the switching contacts in the region of the contact regions with the sliding contact points have at least one defined uneven area. By the uneven area, for example in the form of a projection or a recess, the sliding resistance between the contact part and the sliding contact points can be influenced, for example increased or reduced, in a defined manner.

Another preferred embodiment of the switching device is characterized in that the actuator is sealed towards the housing by means of a sealing element. Due to the sealing element, it is ensured that as few contaminants as possible can enter the interior of the housing. In addition, the reduction of noise created by the snap-action switching mechanism is achieved by means of the sealing element. Switching devices with snap-action switching mechanisms generally generate noise which might be disturbing. Due to a sealing of the housing, noise may be reduced considerably.

Another preferred embodiment of the switching device is characterized in that the housing cover is sealed the housing by means of a sealing element. Preferably, the sealing element is formed in such a manner that it seals the housing and the housing cover circumferentially. By sealing the connection between the housing and the housing cover, a further reduction of disturbing noise is achieved. The housing cover may preferably be connected to the trough-shaped housing by means of a snap-action connection, for example. Alternatively, the housing cover may also be permanently fixed—for example glued or welded—to the housing mechanically. If the housing cover is welded or glued to the housing, the further sealing element can be omitted, provided that it is ensured that the adhesive joint or the weld forms a sufficient sealing.

A preferred embodiment of the switching device is characterized in that the housing is formed in a trough-shaped manner. A trough-shaped housing means that the housing has a bottom from which preferably four side walls extend preferably vertically upwards. In the bottom of the housing, preferably there are apertures through which the metal contact elements are lead through. Preferably, the lead-through apertures are adjusted to the size and shape of the metal contact elements in a form-fit manner. By means of a trough-shaped housing, it is possible to effectively prevent that liquid soldering material may enter the interior of the housing, for example when the switching device is soldered. If a trough-shaped housing with a circumferential sealing element between the housing and the housing cover is used, a particularly tight sealing of the housing is achieved. It is also possible, however, that the housing cover is glued or welded to the housing. In this case, an additional sealing element can still be provided as well, or the additional sealing element can be omitted.

Another preferred embodiment of the switching device is characterized in that due to the design, the snap-action switching mechanism is held in an unpressed position if no pressure is applied to the actuator. The snap-action switching mechanism is in a stable position when the actuator is in an unpressed position. In the pressed position of the actuator, the snap-action switching mechanism is in an unstable position.

Due to the embodiments of the switching device according to the invention described above, it is possible to carry out the switching operation easily and reliably.

Further advantages, features and details of the invention result from the further description, in which an exemplary embodiment is described in detail with reference to the drawings.

### BRIEF DESCRIPTION OF THE DRAWINGS

FIG. 1 shows a three-dimensional view of an embodiment of the switching device according to the invention;

FIG. 2 shows a cross-section through the switching device according to FIG. 1;

FIGS. 3a and 3b show various views of the switching device without the housing;

FIG. 4 shows a contact part;

FIG. 5 shows a further view of the switching device without the housing when being actuated;

FIGS. 6a and 6b show various views of the snap-action switching mechanism of the switching device;

FIG. 7 shows a three-dimensional view of the second actuator-element of the snap-action switching mechanism; and

FIGS. 8a and 8b show various views of the arrangement of the second actuator-element in the housing of the switching device.

### DETAILED DESCRIPTION

FIG. 1 shows a three-dimensional view of an embodiment of the switching device 1. The switching device 1 comprises a housing 2 having a housing cover 23. In order to actuate the switching device 1, the latter has an actuator 3 which can be actuated via a top face of the switching device 1. The actuator 3 is sealed towards the housing cover 23 by means of a sealing element 13. A plurality of contact elements 5, 6, 7, 15, 16, 17 for contacting the switching device 1 projects from the bottom surface of the housing 2 of the switching device 1.

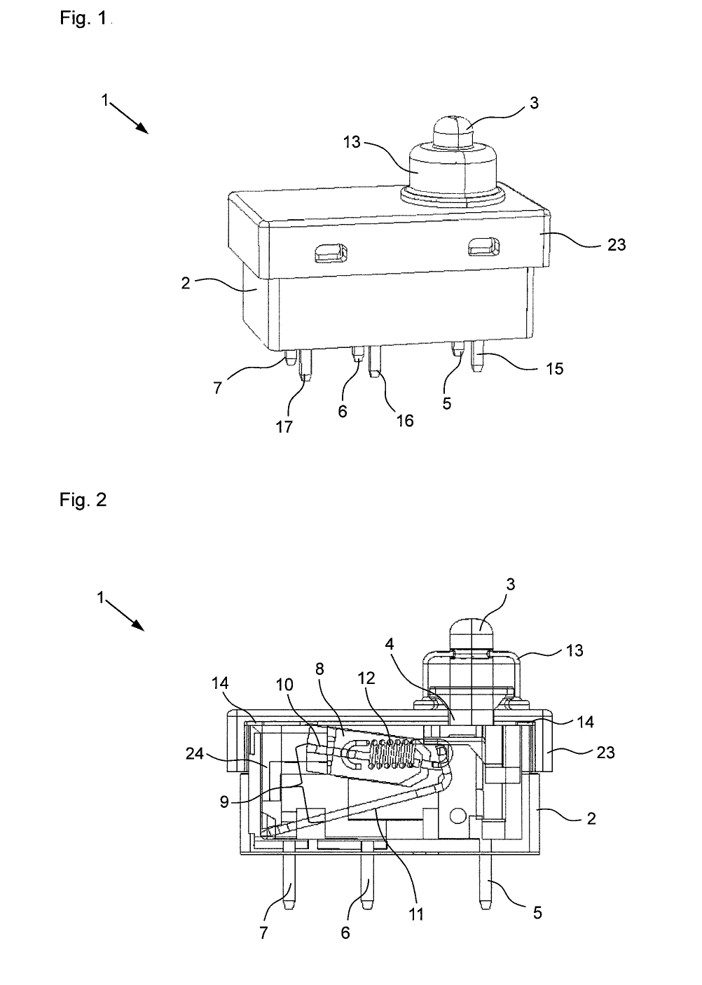

FIG. 2 shows a cross-section through the switching device 1 according to the embodiment illustrated in FIG. 1. A snap-action switching mechanism 9 is arranged inside the trough-shaped housing 2 of the switching device 1. The snap-action switching mechanism 9 comprises a first actuator-element 10 and a second actuator-element 11 being connected to each other by means of a tension spring 12. For actuating the switching device 1, pressure is applied to the top side of the switching device 1 by means of the actuator 3. The actuator 3 is guided to the outside through an aperture 4 in the housing cover 23. In the illustrated embodiment, a circumferential sealing element 14 is arranged between the housing 2 and the housing cover 23. Due to the sealing element 14, the connection between the housing 2 and the housing cover 23 is protected against penetrating contaminants, whilst a reduction of noise penetrating to the outside is achieved when the snap-action switching mechanism 9 is actuated.

The actuator 3 transmits the pressure to the second actuator-element 11, which thereby pivots downwards at the same time. The second actuator-element 11 is supported on the left inner edge of the housing 2. In the region of the supporting point of the second actuator-element 11, the housing cover 23 has a shank extending from the housing cover 23 into the housing 2. Preferably, the shank 24 projects into the housing 2 to such a depth that in the region of its supporting point, the second actuator-element 11 is prevented from moving upwards undesirably in the vertical direction. The shank 24 leaves sufficient space for the second actuator-element 11 such that the rotary movement for the snapping of the snap-action switching mechanism 9 is still possible. Alternatively, on the inner wall of the housing 2, a sufficiently large dimensioned projection may be provided instead of a shank 24 on the inner wall of the housing 2 in this region, with said projection starting from the housing cover 23 and fulfilling the same function as the shank 24.

Due to the movement of the second actuator-element 11, the tension spring 12 is tensioned, moving the first actuator-element 10 from its stable resting position as soon as the tensile force of the tension spring is great enough. The first actuator-element 10 pivots downwards, with the electrical connection between the common contact element 5 and a contact element 7 being switched over to the further contact element 6. If no pressure is applied to the actuator 3, the snap-action switching mechanism 9 snaps back from its unstable position to its stable resting position illustrated in FIG. 2.

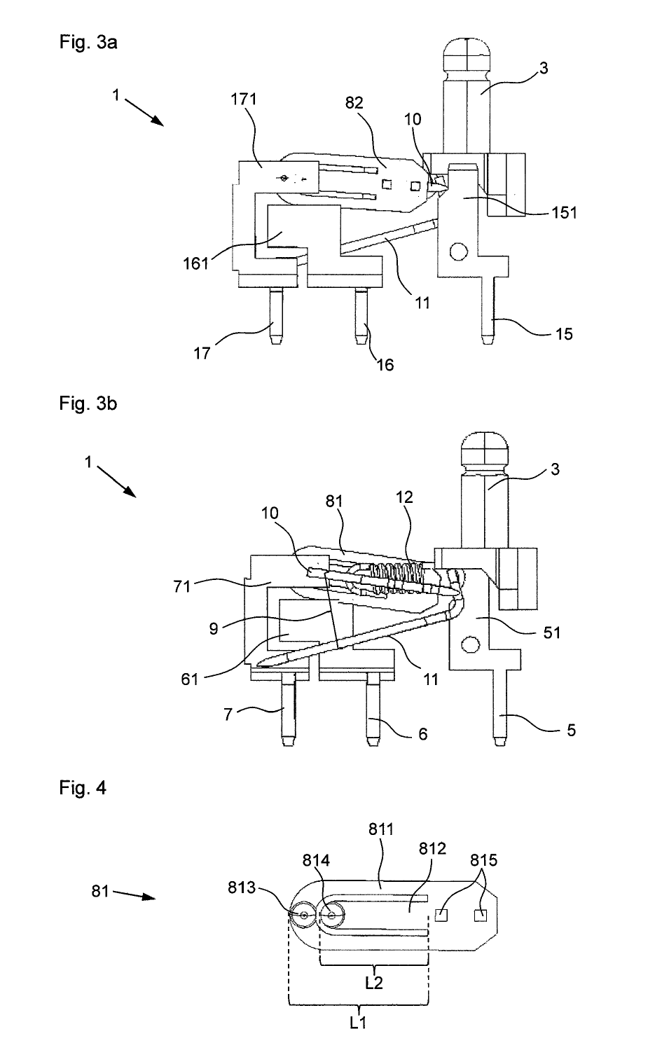

FIGS. 3a and 3b show various views of the switching device 1 without the housing 2. As can be seen in FIG. 3a, the first actuator-element 10 of the snap-action switching mechanism is supported on a common contact 151. The supporting point of the first actuator-element 10 on the common contact 151 forms the fulcrum of the first actuator-element 10. A contact part 82 is placed at the first actuator-element 10. The contact part 82 is arranged parallel to the first actuator-element 10. During the movement of the first actuator-element 10, the contact part 82 is moved as well such that the contact part 82 is likewise pivoted during the pivoting movement of the first actuator-element 10 between the first switching contact 171 and the second switching contact 161. Together with the first actuator-element 10, the contact part 82 forms an electrically conductive connection between the contact element 15 and the two further contact elements 16 and/or 17.

The first actuator-element 10 is pivot-mounted with one end at a supporting point at the common contact points 51. In the illustrated embodiment, the supporting point is constructed in the form of a step at the common contact points 51. In this region, the housing cover 23 preferably has a shank which extends into the housing 2 and prevents the first actuator-element 10 from moving too far from the supporting point in the upward direction. Alternatively, this can be achieved by a geometrical design of the common contact points 51, for example in the form of a notch.

In the embodiment of the switching device 1 illustrated in FIG. 3b, the front contact elements 15, 16, 17 as well as the front contact part 82 were removed such that the snap-action switching mechanism 9 between the contact elements 15, 16, 17 and/or 5, 6, 7 is visible.

FIG. 4 shows an embodiment of the contact part 81 by way of an example. The contact part 81 has two spring elements 811 and 812 of different lengths. The length L1 of the first spring element 811 is greater than the length L2 of the second spring element 812. The first spring element 811 surrounds the second spring element 812 in a U-shaped manner.

In further embodiments which are not illustrated, the contact part 81 may have one or a plurality of spring-loaded arms.

At the right-sided end, the contact part 81 has two apertures 815, via which it is attachable to the first actuator-element 10 of the snap-action switching mechanism 9. The contact part 81 can, for example, be permanently connected mechanically to the first actuator-element 10 by means of laser welding, soldering or any other suitable method. At the ends of the spring elements 811, 812 opposite to each other, the latter have switching contact points 813, 814.

Due to the assembly of the contact part 81 having two or more spring elements 811, 812, improved reliability of the switching device is achieved. For some applications, it is, however, sufficient if the contact part 81 has only one spring element.

Due to the arrangement of the spring elements 811, 812, which are of different lengths L1, L2, it is also possible to vary the sliding resistance between the contact part 81 and the switching contacts in a defined manner. For a further increase of the sliding resistance between the switching contacts and the contact part, the switching contacts may be provided with geometrically designed projections, recesses etc., which have to be overcome by the switching contact point/s of the spring elements before a switching operation. Due to such geometrical design of the switching contacts, a defined sliding resistance is adjustable.

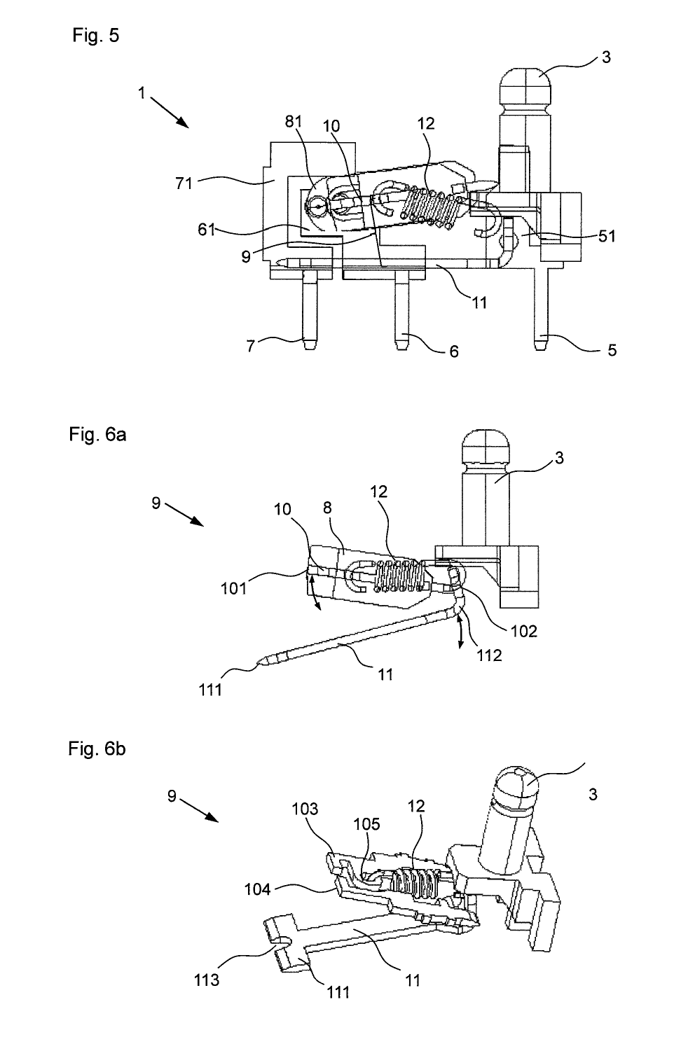

FIG. 5 shows a further view of the switching device 1 analogous to the embodiment of the switching device 1 illustrated in FIG. 3b. FIG. 5 shows the switching device 1 during the actuation of actuator 3, wherein the snap-action switching mechanism 9 is snapped over into an unstable position. At this, the contact part 81 abuts on the second switching contact 61.

FIGS. 6a and 6b show various views of the snap-action switching mechanism 9 of the switching device 1. FIG. 6a shows the snap-action switching mechanism 9 together with the actuator 3. The snap-action switching mechanism 9 consists of a first actuator-element 10 and second actuator-element 11 connected to each other by means of a tension spring 12. In the region of a first end 101, the first actuator-element 10 can be pivot-mounted downwards. At the opposite end 102 of the first actuator-element 10, the latter is supported, with the supporting point being pivot-mounted at the common contact point, which is not shown in FIG. 6a. At a first end 111, the second actuator-element 11 is pivot-mounted on an inner edge of the housing 2 of the switching device 1. The opposite second end 112 of the second actuator-element 11 pivots downwards when the actuator 3 is actuated. Preferably, the actuator 3 directly presses the second end 112 of the second actuator-element 11. In FIG. 6a, an insulating part 8 is schematically indicated in the region of the tension spring 12. The insulating part 8 mechanically connects the two components 103, 104 of the first actuator-element 10 to each other. In FIG. 6b, the two components 103, 104 of the first actuator-element 10 can be identified in a three-dimensional view of the snap-action switching mechanism 9.

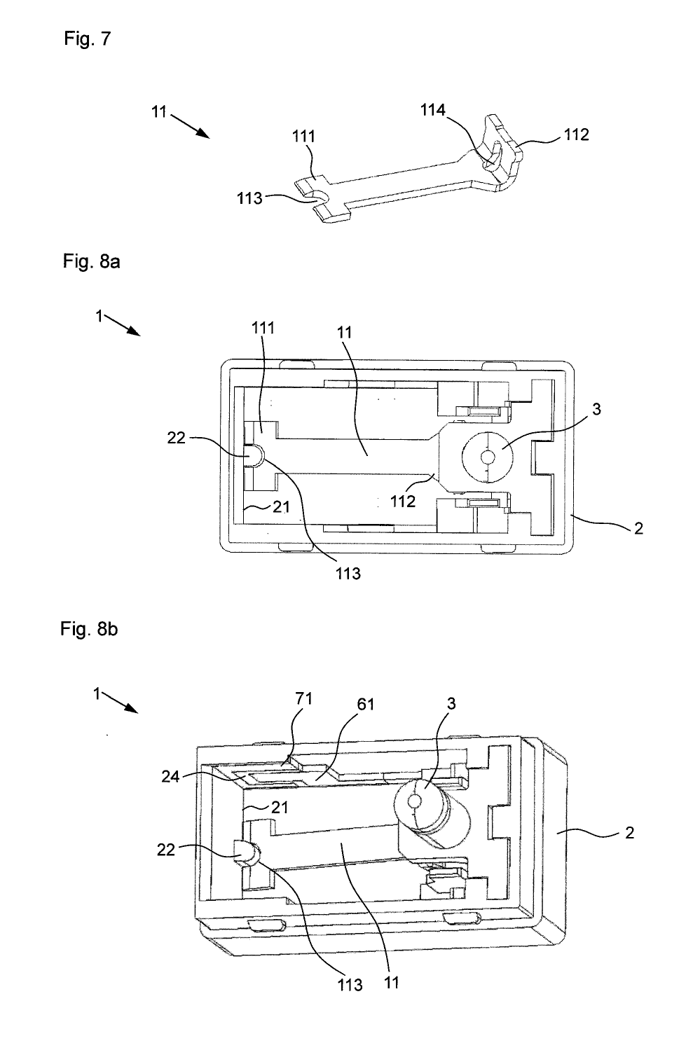

FIG. 6b also reveals that the tension spring 12 is hooked onto a preferably metal eyelet 105 of a component 103 of the first actuator-element 10. Alternatively, the tension spring 12 may also be hooked onto the further component 104 of the first actuator-element 10. By means of the insulating part 8 illustrated in FIG. 6a, which mechanically connects the two components 103, 104 to each other, the force acting on the tension spring 12 thus acts on the two components 103, 104 of the first actuator-element 10. It can also be seem from FIG. 6b that the second actuator-element 11 has a recess 113 at its first end 111. The second actuator-element 11 is shown in detail in FIG. 7.

FIG. 7 shows a three-dimensional view of the second actuator-element 11 of the snap-action switching mechanism 9. At its first end 111, the second actuator-element 11 has a recess 113. In the embodiment of the second actuator-element 11 illustrated in FIG. 7, the recess 113 is designed in a U-shaped manner. At its second end 112, the second actuator-element 11 has an aperture 114. The tension spring 12 illustrated in FIGS. 6a and 6b can be hooked onto the second actuator-element 11 via the aperture 114. In the event of a movement of the second actuator-element 11, tensile force is thus applied to the first actuator-element 10 via the tension spring 12.

FIGS. 8a and 8b show various views of the arrangement of the second actuator-element 11 in the housing 2 of the switching device 1. FIGS. 8a and 8b do not show parts of the snap-action switching mechanism 9 in order to enable a better view of the arrangement of the second actuator-element 11 in the housing 2 of the switching device 1. At its first end 111, the second actuator-element 11 is pivot-mounted on an inner edge 21 of the housing 2. On the inner edge 21 of the housing 2, a projection 22 is preferably arranged, which engages with the recess 113 at the first end 111 of the second actuator-element 11. Due to the projection 22 and the recess 113, the second actuator-element 11 is prevented from laterally slipping within housing 2. The shape of the projection 22 and the shape of the recess 113 are designed in such a way that they are as compatible as possible with each other. The shape of the projection 22 and the shape of the recess 113 are not limited to the shapes illustrated in the figures.

FIG. 8b also reveals that the two switching contacts 61 and 71 on the inner wall of the housing 2 are mounted in such a way that a part 24 of the inner wall of the housing 2 is arranged between the two switching contacts 61, 71 such that the surface extending from the first switching contact 61 across the inner wall of the housing 2 to the second switching contact 71 is as plane as possible. As a result, the contact part 81 can easily slide between the two switching contacts 61 and/or 71 when first contact part is moved. The inner wall of the housing 2 on the opposite side in the region of the further switching contacts 161 and/or 171 is designed correspondingly. The common contact points 51, at which the first actuator-element 10 is pivoted, are preferably arranged in such a way that they are spaced from the side walls of the housing 2 in order that the first actuator-element 10 may be pivot-mounted thereon. Preferably, the common contact points 51 are, however, laterally spaced from each other at such a distance that there is sufficient space for the actuator 3 to be moved up and down between the common contact points 51.

FIGS. 1 to 8b show only one embodiment of the switching device having two groups of three contact elements (5, 6, 7 and/or 15, 16, 17). The switching device is, however, not limited to this embodiment. For example, the switching device can have more than two groups of contact elements, respectively. Preferably, a snap-action switching mechanism is arranged between two adjacent groups of contact elements. Preferably, a plurality of snap-action switching mechanisms can be actuated by means of a common actuator such that a synchronous switching operation is carried out for all groups of contact elements.

In the embodiment of the switching device 1 illustrated in FIGS. 1 to 8b, the contact part is disconnected at first from the first switching contact during a switching operation before the contacting of the second switching contact takes place. Alternatively, the contacting of the second switching contact can already take place before the disconnection from the first switching contact has been established.

Even though the switching device according to the invention is shown in FIGS. 1 to 8b only with respect to an embodiment having one common contact point and two switching contacts, it is also possible that the switching device according to the invention has only one switching contact on each side which, when the snap-action switching mechanism is actuated, establishes an electrical connection between the common contact point and a switching contact from an unswitched position or a disconnection of the electrical connection from a switched position into an unswitched position.

### LIST OF REFERENCE CHARACTERS

1 switching device
2 housing
21 inner edge of the housing 2
22 projection on the inner edge 21
23 housing cover
24 shank
3 actuator
4 aperture in the housing cover 23
5 contact element
51 common contact point
6 contact element
61 switching contact
7 contact element
71 switching contact
8 insulating element
81 contact part
811 spring element
812 spring element
813 switching contact point
814 switching contact point
815 aperture
82 contact part
9 snap-action switching mechanism
10 first actuator-element
101 first end of the first actuator-element 10
102 second end of the first actuator-element 10
103 component of the first actuator-element 10
104 component of the first actuator-element 10
105 eyelet
11 second actuator-element
111 first end of the second actuator-element 11
112 second end of the second actuator-element 11
113 recess
114 aperture
12 tension spring
13 sealing element
14 sealing element
15 contact element
151 common contact point
16 contact element
161 switching contact
17 contact element
171 switching contact
L1 length of the spring element 811
L2 length of the spring element 811

In view of the foregoing, it will be seen that several advantages are achieved and attained. The embodiments were chosen and described in order to best explain the principles of the invention and its practical application to thereby enable others skilled in the art to best utilize the invention in various embodiments and with various modifications as are suited to the particular use contemplated. As various modifications could be made in the constructions and methods herein described and illustrated without departing from the scope of the invention, it is intended that all matter contained in the foregoing description or shown in the accompanying drawings shall be interpreted as illustrative rather than limiting. The breadth and scope of the present invention should not be limited by any of the above-described exemplary embodiments, but should be defined only in accordance with the following claims appended hereto and their equivalents.

What is claimed is:

1. A switching device comprising:
a housing (2);
an actuator (3) for receiving a pressure actuation;
at least two metal contact elements (5, 6), wherein at least one contact element (5) is a common contact point (51) and at least one further contact element (6) is a switching contact (61), wherein the contact elements (5, 6) electrically contactable from the outside of the housing (2); and
a snap-action switching mechanism (9) being actuated when the actuator (3) is pressed into the designated position;
wherein the snap-action switching mechanism (9) has at least a first actuator-element (10) on which at least one contact part (81) is mounted adjacent to a first end (101) of the first actuator-element (10), the at least one contact part (81) is adapted and configured for at least one of disconnection and contacting with at least one switching contact (61), the at least one contact part (81) is pivot-mounted with a second end (102) of the first actuator-lement (10) at the common contact point (51);
wherein the snap-action switching mechanism (9) has a second actuator-element (11) which is adapted and configured for receiving a pressure actuation by means of the actuator (3) via a first end (111) of the second actuator-element (11) and which is pivot-mounted at a second end (112) of the second actuator-element (11) on the inner edge (21) of the housing (2) opposite to the common contact (51) of the housing (2); and
wherein the snap-action switching mechanism (9) has tension spring (12) arranged between the first actuator-element (10) and the second actuator-element (11).

2. A switching device according to claim 1, wherein the second actuator-element (11) has at least one recess (113) at its second end (112) in which at least one projection (22) engages on the inner edge (21) of the housing (2), thereby securing the second actuator-element (11) against lateral slipping.

3. A switching device according to claim 1, wherein the contact part (81) is connected to the first actuator-element (10) and is pre-stretched against the at least one switching contact (61).

4. A switching device according to claim 1, wherein the switching contact (61) is arranged laterally towards an inner wall of the housing (2).

5. A switching device according to claim 1, wherein the switching mechanism comprises at least two second metal contact elements (15, 16) that are arranged parallel to the at least two first metal contact elements (5, 6).

6. A switching device according to claim 5, wherein the at least two second metal contact elements (15, 16) are electrically insulated from the at least two first metal contact elements (5, 6).

7. A switching device according to claim 6, wherein the at least won second metal contact elements (15, 16) are electrically contactable from the outside of the housing (2) and comprise a common contact point (151) and at least one switching contact (161).

8. A switching device according to claim 7, wherein the first actuator-element (10) has a further contact part (82) for at least one of the disconnection and contacting with the further switching contact (161), the further contact part (82) is pre-stretched against the further switching contact (161).

9. A switching device according to claim 8, wherein the two contact parts (81, 82) are connected to the first actuator-element (10) and are electrically insulated from each other.

10. A switching device according to claim 9, wherein the first actuator-element (10) has two components (103, 104) being mechanically connected to each other.

11. A switching device according to claim 10, wherein the two components (103, 104) of the first actuator-element (10) are mechanically connected to each other by means of an insulating element (8).

12. A switching device according to claim 1, wherein the switching contact is adapted and configured to be connected to the common contact point in an electrically conductive manner and disconnected from the common contact point when the snap-action switching mechanism is in a stable position.

13. A switching device according to claim 1, further comprising a further metal contact element which is contactable from the outside of the housing and which forms a further switching contact, wherein the snap-action switching mechanism for the at least one of disconnection and contacting is provided between the first switching contact and the second switching contact.

14. A switching device according to claim 1, wherein the contact part has a plurality of spring elements of different lengths.

15. A switching device according to claim 14, wherein the spring elements have ends that abut the switching contacts, the spring element ends have at least one switching contact point projecting above the spring elements.

16. Switching device according to claim 15, wherein the switching contacts have at least one defined uneven spot in the region of the contact regions with the sliding contact points.

17. A switching device according to claim 1, wherein the actuator (3) and the housing cover (23) are sealed by means of a sealing element (13).

18. A switching device according to claim 1, wherein the housing (2) is formed in a trough-shaped manner.

19. A switching device according to claim 1, wherein the snap-action switching mechanism (9) holds the actuator (3) in an unpressed position when assembled in the housing.
